(19) United States
(12) Patent Application Publication
(10) Pub. No.: US 2010/0245941 A1
(43) Pub. Date: Sep. 30, 2010

(54) METHOD AND DEVICE FOR DETECTING DEFECTIVE LIQUID EJECTION

(75) Inventors: Tsuneo Kasai, Azumino-shi (JP); Hidekuni Moriya, Chino-shi (JP); Kenji Fukasawa, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/730,135

(22) Filed: Mar. 23, 2010

(30) Foreign Application Priority Data
Mar. 24, 2009 (JP) 2009-072465

(51) Int. Cl. H04N 1/04

(52) U.S. Cl. 358/474

(57) ABSTRACT

A method for detecting defective liquid ejection includes: reading an image with a sensor, the image being formed on a medium on the basis of image data by ejecting liquid from a nozzle while relatively moving the nozzle in a direction of relative movement with respect to the medium; specifying a maximum pixel among pixels of read data continuously arrayed in rows in a direction intersecting the direction of the relative movement in the data read with the sensor, the maximum pixel having the maximum pixel value among pixels of the read data; selecting a selected pixel in the data read with the sensor, the selected pixel being included in a line constituted by a plurality of pixels including the maximum pixel arrayed in line in the direction of the relative movement; and detecting defective liquid ejection in the nozzle by comparing the selected pixel with the pixel of the image data corresponding to the selected pixel in the image data.

### BACKGROUND

1. Technical Field

The present invention relates to a method and a device for detecting defective liquid ejection.

2. Related Art

There has been provided a technique including: reading an image with a sensor, the image being formed on a medium on the basis of image data by ejecting liquid from a nozzle while relatively moving the nozzle with respect to the medium; creating reference data having the same resolution as a read resolution on the basis of the image data; and detecting defective liquid ejection in the nozzle by comparing the data read by the sensor with the reference data. For example, JP-A-2008-64486 discloses a technique for detecting a defection by comparing a reference image with a test image in a printed material.

The techniques of the related art have, however, a problem in which a false detection may be caused by a read error of a sensor.

### SUMMARY

An advantage of some aspects of the invention is that it prevents a false detection due to a read error of a sensor. The description herein and the appended drawings clarify the following.

According to an aspect of the invention, there is provided a method for detecting defective liquid ejection. The method includes: reading an image with a sensor, the image being formed on a medium on the basis of image data by ejecting liquid from a nozzle while relatively moving the nozzle in a direction of relative movement with respect to the medium; specifying a maximum pixel among pixels of read data continuously arrayed in rows in a direction intersecting the direction of the relative movement in the data read with the sensor, the maximum pixel having the maximum pixel value among pixels of the read data; selecting a selected pixel in the data read with the sensor, the selected pixel being included in a line constituted by a plurality of pixels including the maximum pixel arrayed in line in the direction of the relative movement; and detecting defective liquid ejection in the nozzle by comparing the selected pixel with the pixel of the image data corresponding to the selected pixel in the image data. This advantage leads to it being possible to prevent false detection in the detection of the defective liquid ejection by performing the detection for the maximum pixel value.

It is preferable that the method for detecting the defective liquid ejection may includes creating reference data on the basis of the image data, the reference data having the same resolution as the read data. In this case, the sensor performs reading in the direction of the relative movement so that the resolution of the read data is made to be lower than that of the image data in cases where an image formed on the medium is read with the sensor. In addition, the selected pixel is compared with the pixel of the reference data corresponding to the selected pixel in the reference data in cases where defective liquid ejection of the nozzle is detected. This advantage leads to it being possible to reduce the amount of data to be processed in the detection of defective liquid ejection while the accuracy of detection is maintained.

It is preferable that the sensor performs reading in the direction intersecting the direction of the relative movement so that the resolution of the read data becomes higher than that of the image data. This advantage leads to it being possible to detect which nozzle has defective liquid ejection in the case of the occurrence of defective liquid ejection.

It is preferable that the reference data is created by processing the image data. This advantage leads to it being possible to create the reference data having enough accuracy to detect defective liquid ejection, so that defective liquid ejection may be appropriately detected.

In another aspect of the invention, there is provided a device for detecting defective liquid ejection. The device includes: a sensor for reading an image, the image being formed on a medium on the basis of image data by ejecting liquid from a nozzle while relatively moving the nozzle in a direction of relative movement with respect to the medium; a specifying section for specifying a maximum pixel among pixels of read data continuously arrayed in rows in a direction intersecting the direction of the relative movement in the data read with the sensor, the maximum pixel having the maximum pixel value in pixels of the read data; a selecting section for selecting a selected pixel in the data read with the sensor, the selected pixel being included in a line constituted by a plurality of pixels including the maximum pixel arrayed in line in the direction of the relative movement; and a detector for detecting defective liquid ejection in the nozzle by comparing the selected pixel with the pixel of the image data corresponding to the selected pixel in the image data. This advantage leads to it being possible to prevent false detection in the detection of the defective liquid ejection by performing the detection for the maximum pixel.

### BRIEF DESCRIPTION OF THE DRAWINGS

The invention will be described with reference to the accompanying drawings, wherein like numbers reference like elements.

FIG. 1 is a block diagram illustrating the configuration of a printing system used in an embodiment of the invention.

FIG. 2 is a cross sectional view illustrating the general configuration of a printer.

FIG. 3 is an explanatory diagram illustrating the array of a plurality of heads provided on the under surface of a head unit.

FIG. 4 shows the arrangement of nozzles in a head.

FIG. 5 is an explanatory diagram for a simplified explanation illustrating the arrangement of nozzles and dot forming.

FIG. 6A shows a printed image in the case of the occurrence of defective liquid ejection.

FIG. 6B is an enlarged view of the portion having a dot defect surrounded by a square in FIG. 6A.

FIG. 7 is an explanatory diagram illustrating read data read with a scanner in cases where scanning rate is set at 7 ms.

FIG. 8A shows an image formed by reading the printed image in FIG. 6A with a scanner.

FIG. 8B is an enlarged view of the portion having a dot defect surrounded by a square in FIG. 8A.

FIG. 9 is a flow chart illustrating a process for detecting defective liquid ejection.

FIG. 10 is part of a line graph in which pixel values of the pixels of read data in a read line are plotted.

FIG. 11 is part of a line graph in which pixel values of the pixels of read data, the pixel values of the pixels of reference data, and difference between them are plotted.

FIG. 12A is a block diagram schematically illustrating the general configuration of a serial printer.

FIG. 12B is a cross sectional view illustrating the general configuration of a printer.

FIG. 13 is an explanatory diagram illustrating read data read with a scanner in cases where the scanning rate is set at 7 ms.

### DESCRIPTION OF EXEMPLARY EMBODIMENTS

### First Embodiment

### General Configuration

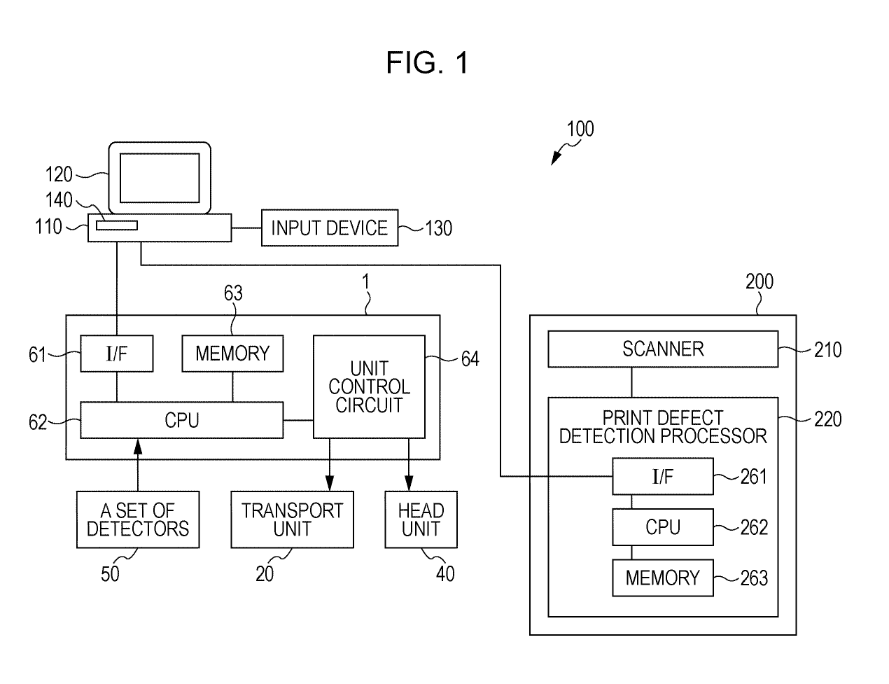

FIG. 1 is a block diagram illustrating the configuration of a printing system 100 used in a first embodiment of the invention. With reference to FIG. 1, the printing system 100 includes a printer 1, a computer 110, a display device 120, an input device 130, a recording and reproducing device 140, and a detector 200 as an example of a device for detecting defective liquid ejection. The printer 1 prints images on mediums such as paper, cloth, and a film. The computer 110 is communicably connected to the printer 1 and outputs image data in accordance with an image to be printed to the printer 1 in order to cause the printer 1 to print the image.

A printer driver is installed in the computer 110. The printer driver is a program for displaying a user interface on the display device 120 and converting image data output from an application program into image data for printing. This printer driver is stored in a recording medium (a recording medium readable in computers) such as a flexible disk (FD) or a compact disk-read only memory (CD-ROM). On the other hand, this printer driver can be downloaded to the computer 110 via the internet. In addition, this program is made of codes for executing various functions.

### The Configuration of the Printer 1

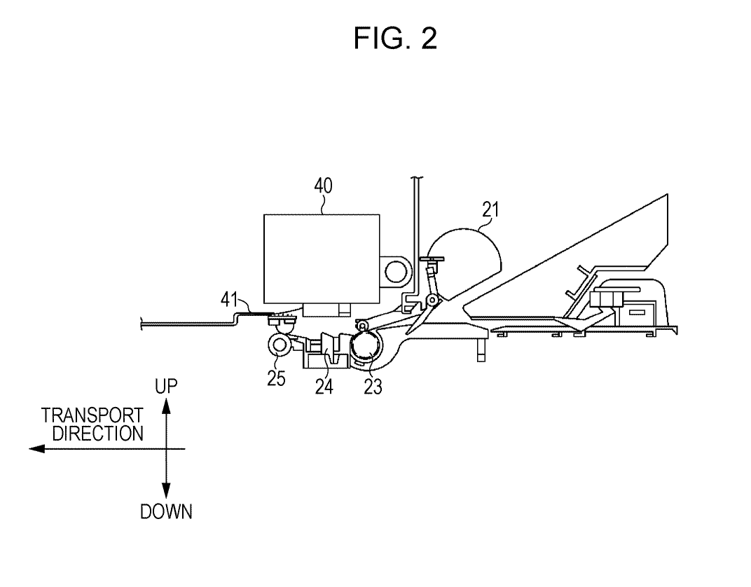

FIG. 2 is a cross sectional view illustrating a general configuration of the printer 1. The printer 1 includes a transport unit 20, a head unit 40, a set of detectors 50, and a controller 60. In the printer 1 after receiving image data from the computer 110 as an external device, the controller 60 controls each unit (the transport unit 20, head unit 40). The controller 60 controls each unit on the basis of the image data received from the computer 110, and an image is printed on paper. A set of detectors 50 monitors a status of the printer 1 and outputs the result of the monitoring to the controller 60. The controller 60 controls each unit on the basis of the result output from the set of detectors 50.

The transport unit 20 transports a medium (for example, paper 0) in a transport direction. The transport unit 20 includes a paper feed roller 21, a transport motor (not shown), a transport roller 23, a platen 24, and a paper ejection roller 25. The paper feed roller 21 feeds paper inserted into a paper insertion opening into the printer. The transport roller 23 transports the paper 0 fed by the paper feed roller 21 to an area in which printing can be conducted, and is driven by the transport motor. The platen 24 supports the paper 0 during printing. The paper ejection roller 25 ejects the paper 0 to the outside of the printer and is disposed downstream in the transport direction relative to the area in which printing can be conducted. This paper ejection roller 25 synchronously rotates with the transport roller 23.

The paper 0 is pinched between the transport roller 23 and a driven roller, while the transport roller 23 transports the paper 0. This enables the position of the paper 0 to be stabilized. On the other hand, the paper 0 is pinched between the paper ejection roller 25 and the driven roller, while the paper ejection roller 25 transports the paper 0.

The head unit 40 ejects ink onto the paper 0. The head unit 40 ejects ink onto the paper 0 being transported, so that dots are formed on the paper 0, resulting in an image being printed on the paper 0. The printer 1 is a line printer, and the head unit can form dots within the width dimension of the paper at one time.

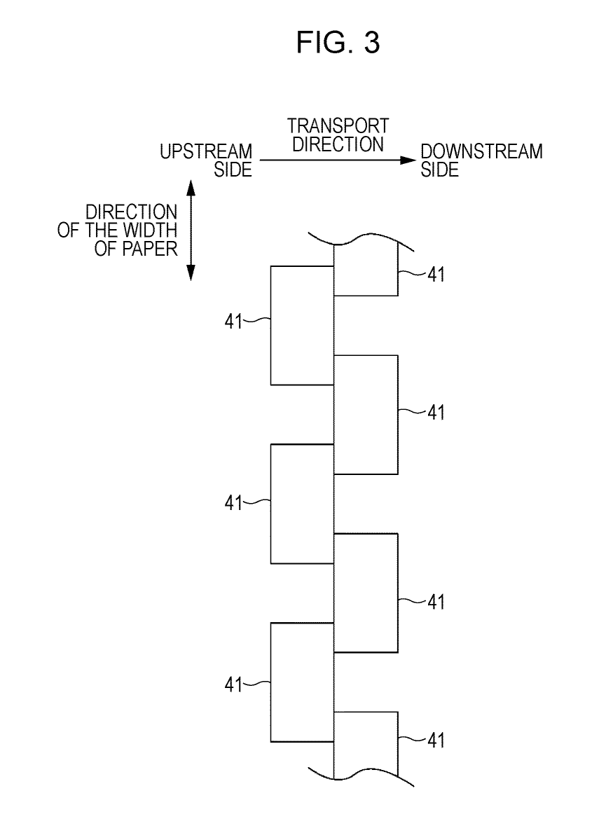

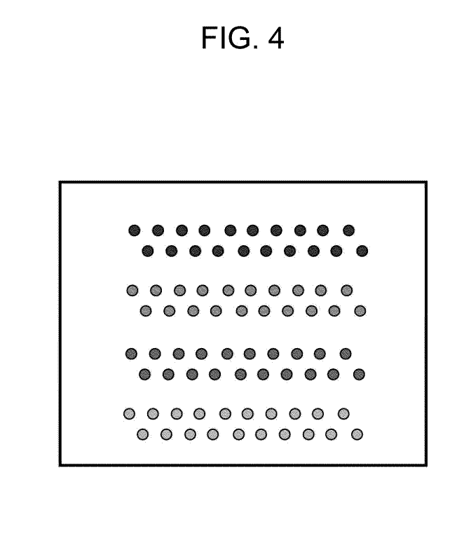

FIG. 3 is an explanatory diagram illustrating the array of a plurality of heads provided on the under surface of the head unit 40. With reference to FIG. 3, a plurality of heads 41 are disposed in staggered rows along a direction of the width of paper. FIG. 4 shows the array of nozzles in the head 41. With reference to FIG. 4, the array of nozzles of black ink, cyan ink, magenta ink, yellow ink is formed in each head 41. Each array of nozzles has a plurality of nozzles that eject ink. A plurality of nozzles in each array of the nozzles is disposed along the direction of the width of paper at a certain nozzle pitch. In other words, the array of nozzles in each head 41 constitutes a set of nozzles within the width dimension of the paper.

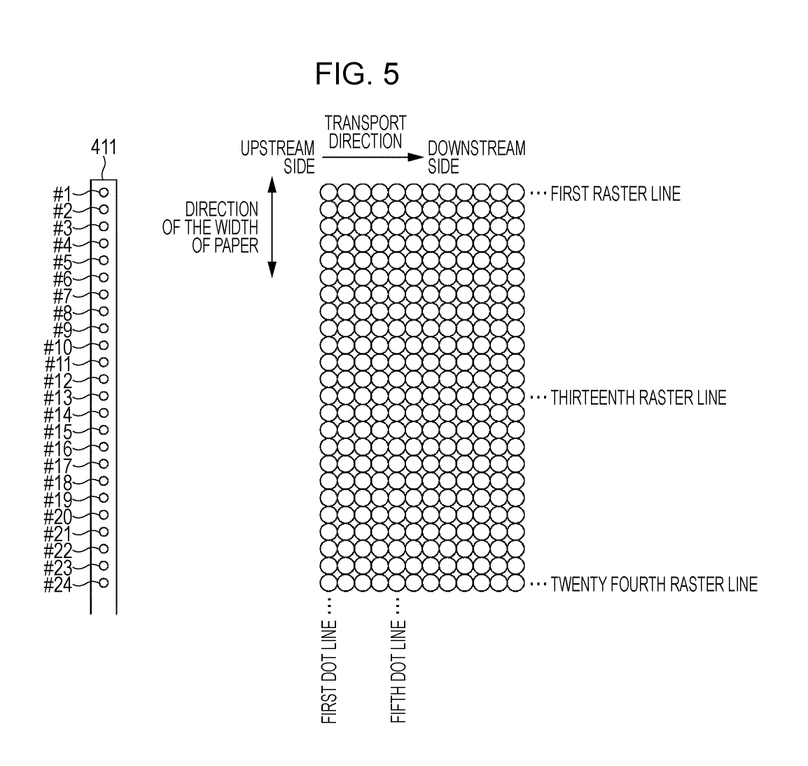

FIG. 5 is an explanatory diagram for a simplified explanation illustrating the arrangement of nozzles and dot forming. In the head unit 40, the rows of the nozzles in each head constitute a set of nozzles having a certain nozzle pitch. Although the actual positions of nozzles in the transport direction vary as shown in FIGS. 3 and 4, variations in liquid ejection timing allow a set of nozzles including the array of nozzles in each head to be seen as nozzles disposed in line as shown in FIG. 5. In addition, to simplify explanation, it is assumed that only a set of nozzles of black ink is provided.

Such a set of nozzles includes nozzles disposed in the direction of the width of paper at an interval of 1/720 of an inch. The individual nozzles are denoted by numbers beginning at the top in FIG. 5.

Each nozzle intermittently ejects ink drops onto the paper 0 being transported, so that a set of nozzles forms a raster line on the paper 0. For example, a nozzle #1 forms a first raster line on the paper 0, and a nozzle # 2 forms a second raster line on the paper 0. Each raster line is formed along the transport direction. The direction of the raster line is referred to as a raster direction (corresponding to “the direction of relative movement”) in the following description.

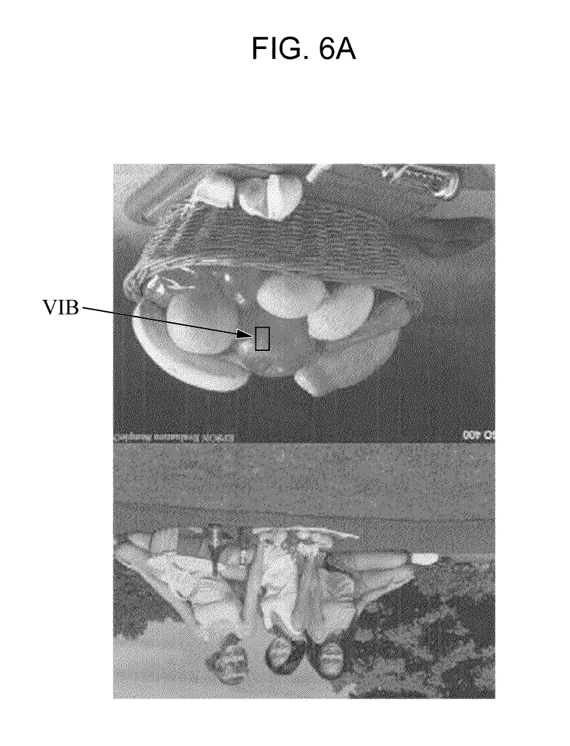

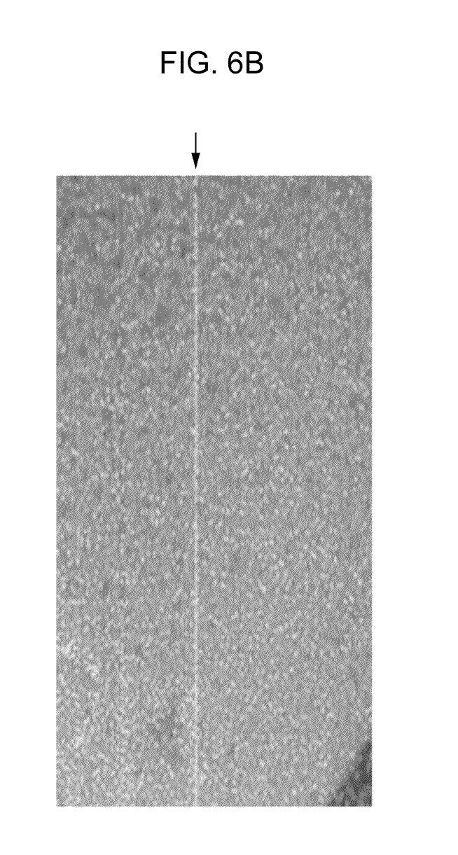

On the other hand, in cases where ink drops are not appropriately ejected due to clogging of a nozzle for example, an appropriate dot is not formed on the paper 0. A dot which is not appropriately formed is referred to as a dot defect in the following description. Because defective liquid ejection almost never recovers by itself during printing once it occurs, the defective liquid ejection continues to occur. Consequently, the dot defect continues to occur on the paper 0 in the raster direction and is observed on a printed image as a white or clear line. FIG. 6A is a printed image in the case of the occurrence of defective liquid ejection. Furthermore, FIG. 6B is an enlarged view of the portion having a dot defect surrounded by a square in FIG. 6A. A longitudinal white line is observed as indicated by an arrow in FIG. 6B.

The controller 60 is a controller unit (control section) for controlling the printer 1. The controller 60 includes an interface section 61, a central processing unit (CPU) 62, a memory 63, and a unit control circuit 64. The interface section 61 exchanges data between the computer 110 as an external device and the printer 1. The CPU 62 is a processor for controlling the whole printer. The memory 63 reserves an area storing the program of the CPU 62 and a work area, and includes memory elements such as a random access memory (RAM) and an electrically erasable programmable read-only memory (EEPROM). The CPU 62 controls each unit through the unit control circuit 64 in accordance with a program stored in the memory 63.

### The Configuration of the Detector 200

With reference to FIG. 1, the detector 200 includes a scanner 210 as an example of a detector and a print defect detection processor 220 as an example of a detecting section.

The scanner 210 is a linear image sensor having a photosensitive units disposed in a line and reads an image printed on the paper 0 by the printer 1 while the paper 0 is transported in the raster direction. A reading portion of the scanner 210 is irradiated with illumination light so that the scanner 210 can read an image printed on the paper 0. The scanner 210 has such a width that an image within the width dimension of the paper 0 can be read at one time, and can read each of every color printable in the printer 1.

A read resolution of the scanner 210 in a direction of the width of the paper is higher than a resolution of an image printed on the paper 0. In particular, in the embodiment, because the resolution of the printed image is 720 dpi in the direction of the width dimension of the paper, the read resolution is preferably 1440 dpi or higher which is more than twice the resolution of the printed image, for example 1440 dpi.

On the other hand, reading is performed so that the read resolution of the scanner 210 in the raster direction is made to be lower than the resolution of the image printed on the paper 0. For example, if the transport rate of the paper 0 is a speed of 254 mm/s and a time required for reading a single read line (one scanning period) is 7 ms, the paper 0 is transported 1.78 mm during reading. In other words, the width of a line in a single read line is 1.78 mm. Accordingly, if a print resolution in a raster direction is 1440 dpi, a single read line corresponds to 1.78 mm×1440 dpi=100.8 dots. Consequently, the read resolution of read data in the raster direction corresponds to an image compressed to approximately one hundredth of the printed image. Each read line of read data includes pixel values which are one averaged pixel values of approximately 100 dots of an image printed in the raster direction with respect to one individual colors.

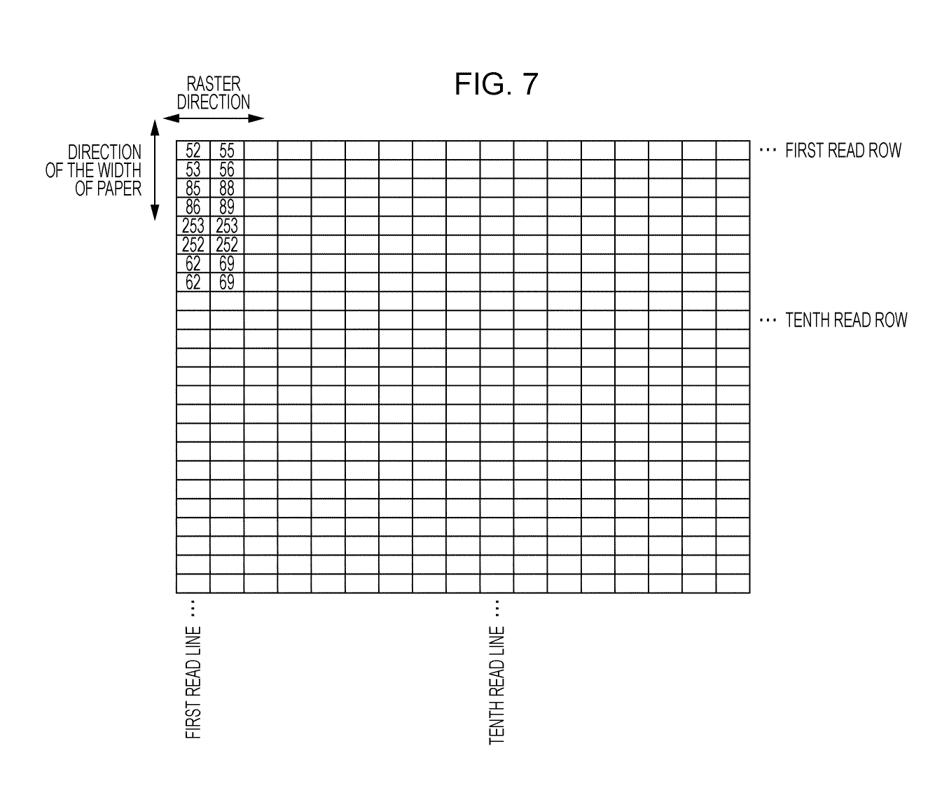

FIG. 7 is an explanatory diagram illustrating read data read with the scanner 210 in cases where the scanning rate is set at 7 ms. As shown in FIG. 7, with respect to cells formed by dividing a plane into a grid in the raster direction and in the direction of the width of paper, the read data has positions of cells and pixel values read in the positions in association with each other. For the purpose of illustration, as shown in FIG. 7, rows in the raster direction are each numbered as a first read row to 1440th read row in sequence, and lines in the direction of the width of paper are each numbered as a first read line to Nth read line in the sequence of reading by the scanner 210, hereinafter.

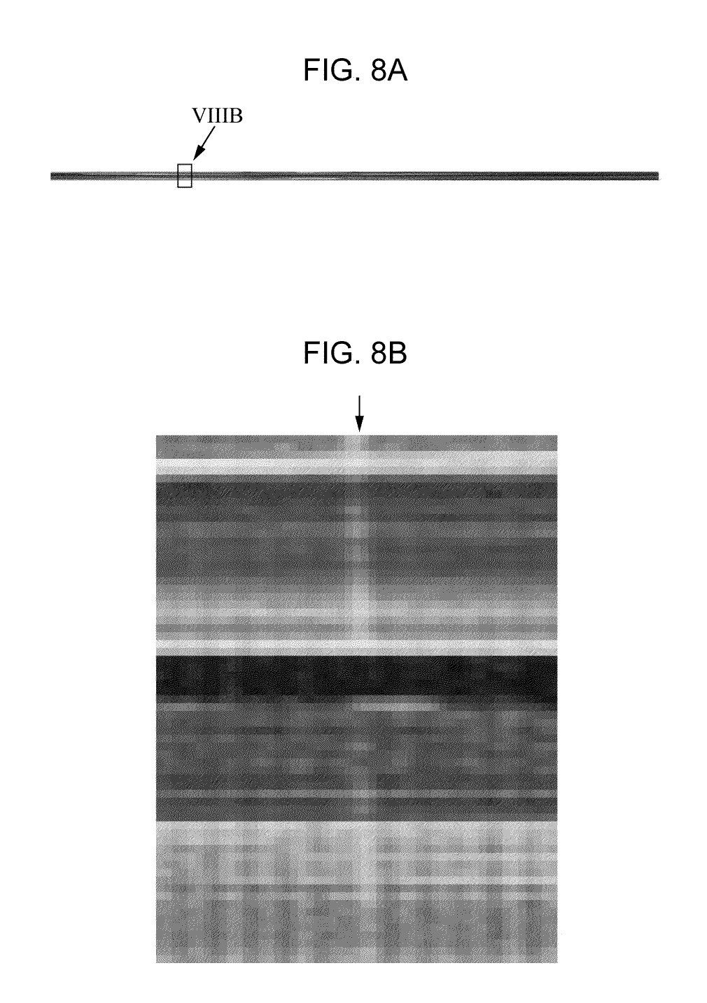

FIG. 8A is an image formed by reading the printed image in FIG. 6A with the scanner 210. As shown in FIG. 8A, an image read with the scanner 210 becomes an image compressed to approximately one hundredth of the read image in a raster direction. On the other hand, FIG. 8B is an enlarged view of the portion of a dot defect surrounded by a square in FIG. 8A. A longitudinal white streak is observed as indicated by an arrow in FIG. 8B.

With reference to FIG. 1, the print defect detection processor 220 includes an interface section 261, a CPU 262, and a memory 263. The interface section 261 exchanges data between the computer 110 as an external device and the detector 200. The CPU 262 is a processor for controlling the detector 200. The memory 263 reserves an area storing the program of the CPU 262 and a work area, and includes memory elements such as a RAM and an EEPROM. The CPU 262 processes data in accordance with a program stored in the memory 263.

The print defect detection processor 220 obtains data of an image read by the scanner 210 (read data) and image data from the printer 1 or the computer 110. Moreover, the print defect detection processor 220 creates reference data having the same resolution as the read resolution of the read data on the basis of the resolution of the image data, so that the read data is compared with the reference data to detect the defective liquid ejection of nozzles.

### Process for Detecting Defective Liquid Ejection in Nozzles

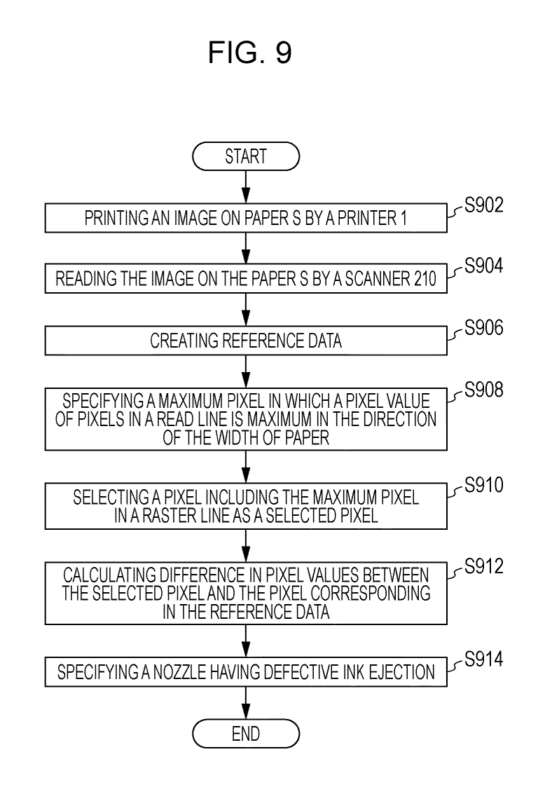

FIG. 9 is a flow chart illustrating a process for detecting defective liquid ejection. First, the printer 1 performs printing on the paper 0 on the basis of image data received from the computer 110 (S₉₀₂). The scanner 210 reads the image printed on the paper 0 in the raster direction so that the read resolution is made to be lower than the resolution of the image data (S₉₀₄). In particular, the scanning rate is set at 7 ms, and reading is performed from a first read line to an Nth read line so that a single read line corresponds to 100.8 dots.

The print defect detection processor 220 obtains image data from the printer 1 or the computer 110 and digitally processes the image data, so that reference data having the same resolution as the read resolution of read data (S₉₀₆). In particular, in a raster line, because a single read line corresponds to 100.8 dots, a dot corresponding to a first read line is calculated by multiplying the pixel value of a 101th dot by 8/10, then adding the resulting value to the sum of the pixel values from the first dot to 100th dots, and then dividing the resulting value by 100.8. The reference data is created with respect to each color. Furthermore, because the read resolution is 1440 dpi in the direction of the width dimension of the paper, image data of 720 dpi is corrected with respect to each color to convert the resolution of the data into 1440 dpi, resulting in creating the reference data. With respect to the read line, the print defect detection processor 220 specifies a maximum pixel which has the maximum pixel value of pixels in the read data in the direction of the width of the paper (S₉₀₈).

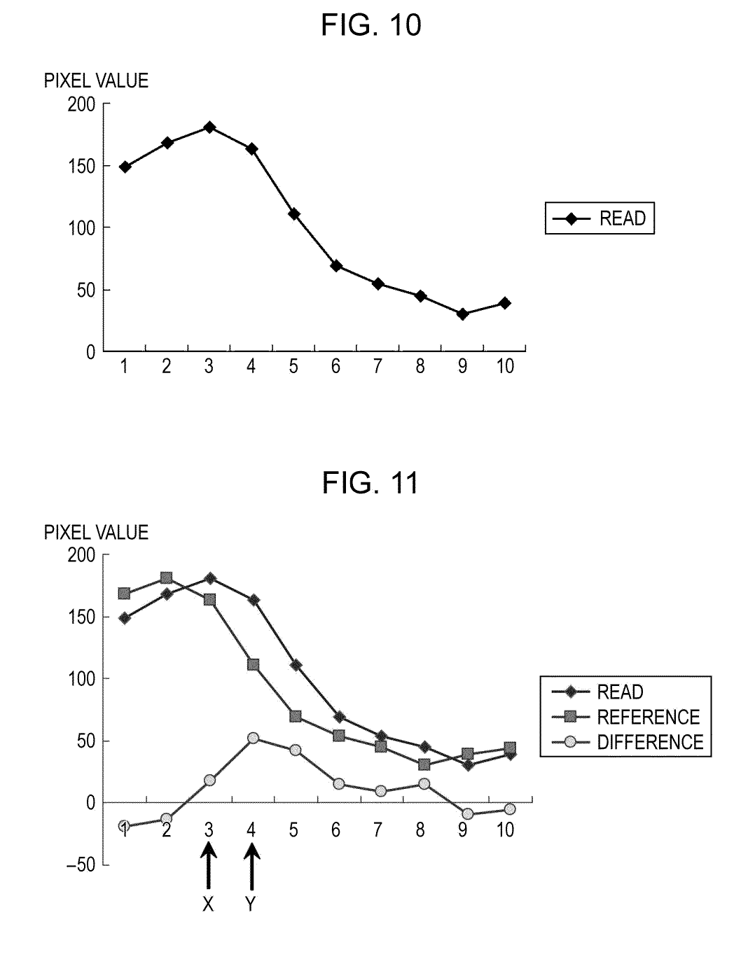

FIG. 10 is part of a line graph in which pixel values of the pixels of read data in a read line are plotted. With reference to FIG. 10, the maximum pixel value of the read data is at the point indicated by an arrow. The term “maximum” means that a pixel value of a pixel in a read line is higher than those of both adjacent pixels. In FIG. 10, although only one point shows the maximum point of pixel value, the pixel values of a plurality of pixels may be maximum points in the read data. The print defect detection processor 220 specifies such a pixel having a maximum pixel value.

The print defect detection processor 220 selects a pixel including the maximum pixel in the raster line as a selected pixel (S₉₁₀). In this case, the maximum pixel may be selected as the selected pixel. The print defect detection processor 220 calculates a difference between the selected pixel and the pixel of the reference data corresponding to the selected pixel in the reference data. In cases where the resultant difference is lower than a predetermined value a, it is determined that a portion having a dot defect does not exist, and in cases where the resultant difference is higher than the predetermined value a, it is determined that a portion having a dot defect exists (S₉₁₂).

If there are no nozzles having defective liquid ejection in the printer 1, and dots are formed in accordance with image data, a difference in pixel values between the reference data and read data is theoretically zero. On the other hand, if there is a nozzle having defective liquid ejection in the printer 1, and dots are not formed by the nozzle, the pixel value of the image data in the portion having a dot defect is theoretically zero, the pixel value of the reference data is directly indicated as the difference. In other words, in cases where a difference in the pixel values does not indicate zero, a dot defect may theoretically exist. However, the difference in the pixel values may not become zero regardless of the absence of the defective liquid ejection, due to a read error of the scanner 210, dusts disposed on the paper 0, and the intensity of illumination light. Therefore, in this embodiment, the predetermined value α is set to determine whether dot defects exist in each read row or not, the predetermined value α being a value between a pixel value of the reference data which is theoretical difference in cases where a dot defect exists and zero which is theoretical difference in cases where a dot defect does not exist. The predetermined value α may be a fixed value or a predetermined percentage of the pixel value of the reference data (for example, 80%).

It is determined that defective liquid ejection is caused in a nozzle corresponding to a read row having a dot defect (S₉₁₄). In this case, an mth nozzle corresponding to an nth read row having a dot defect is specified by following formula:

m=n×(the image resolution of printing/read resolution)

In this case, the scanner 210 performs reading in the direction of the width dimension of one paper at a resolution higher than that of an image printed on the paper 0. Accordingly, specifying a read row having a dot defect in read data can lead to specifying which nozzle has defective liquid ejection.

According to a first embodiment, false detection can be prevented in the detection of the defective liquid ejection. For example, in cases where the scanner 210 reads an image formed on the paper 0, the deformation of the paper 0 may cause slight variations in a read position, the deformation including the expansion of the paper 0 due to absorption of ink drops or wrinkles formed on the paper 0. In cases where variations in the read position occur in this way, the difference in the pixel values between the pixel of the read data and the pixel of the reference data corresponding to the read data does not become zero even when defective liquid ejection does not exist. Furthermore, in a position having a large change in the pixel value of the image, slight variations in a read position increase a difference value, so that the defective liquid ejection may be faultily detected. However, according to the first embodiment, because the defective liquid ejection is detected for a maximum pixel value having a small change in the pixel value of the image, false detection can be prevented.

FIG. 11 is part of a line graph in which the pixel values of the pixels of read data, the pixel values of the pixel of reference data corresponding to the pixels of the read data, and difference between them are plotted, in cases where slight variations locally occur in the alignment of the read position. In this case, it is configured that the defective liquid ejection does not occur, and therefore, the difference in the pixel value between the reference data and the read data should be zero if the position is accurately read. However, in cases where slight variations exist in the read position, a difference in pixel value between the read data and reference data at each position is caused as shown in FIG. 11. In particular, a portion indicated by the arrow Y in which large changes in the pixel value is observed has a large difference, and there is a possibility that false detection as a portion having a dead pixel may be caused. On the other hand, a portion indicated by the arrow X in which small changes in the pixel value are observed has a small difference, and there is a low possibility that false detection as a portion having the dead pixel may be caused. Accordingly, in the first embodiment, a process for calculating the difference in the read row is limited to using the maximum pixel value of the pixel of the read data (a portion indicated by the arrow X), so that false detection due to slight variations in the read position can be prevented.

In addition, the accuracy of the detection of defective liquid ejection is maintained, and read resolution in a raster direction is lowered in the case of reading with the scanner 210, so that an amount of processed data is reduced in the detection of defective liquid ejection.

As shown in FIG. 6B, in cases where defective liquid ejection in a nozzle is caused, the raster line having a dot defect is observed as a white or clear line. In addition, as shown in FIG. 8B, even if the scanner 210 reads 100 dots in the raster direction at one time, it results in only the compression of an image in the raster direction, and a white or clear line is still observed. The inventors have focused on these points. The amount of data to be processed in the detection of defective liquid ejection can be reduced by compressing the amount of data in the raster direction.

On the other hand, a nozzle having defective liquid ejection can be specified by increasing a read resolution in the direction of the width of the paper so as to be more than the resolution of printing.

The invention is useful for printing in large quantity for business purposes. Although continuous printing with a nozzle having defective liquid ejection leads to producing a large amount of defective printed materials, the invention enables defective liquid ejection of a nozzle to be detected during printing, so that the printing can be immediately stopped once defective liquid ejection has occurred. And, a head is cleaned and flushed to eliminate defective liquid ejection such as clogging of the nozzle, and then the printing immediately restarts.

In order to further reduce the amount of data to be processed, it may be configured such that not only defective liquid ejection is detected with respect to all printed materials, but defective liquid ejection is detected at the rate of once every several printed materials. The reduction of the frequency of the detection can lead to the reduction of an amount of data to be processed.

### Second Embodiment

A serial printer is used in a second embodiment, whereas a line printer is used in the first embodiment. The printing system used in the second embodiment includes, similarly to the first embodiment, the printer 1, the computer 110, the display 120, the input device 130, the recording and reproducing device 140, and the detector 200.

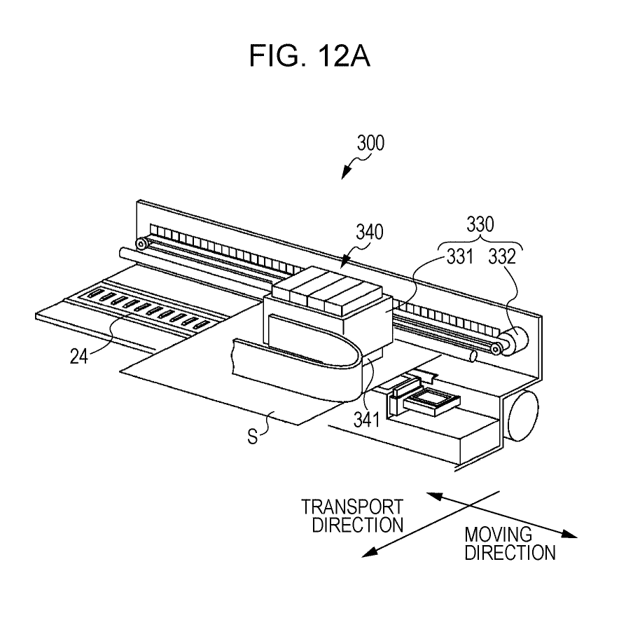

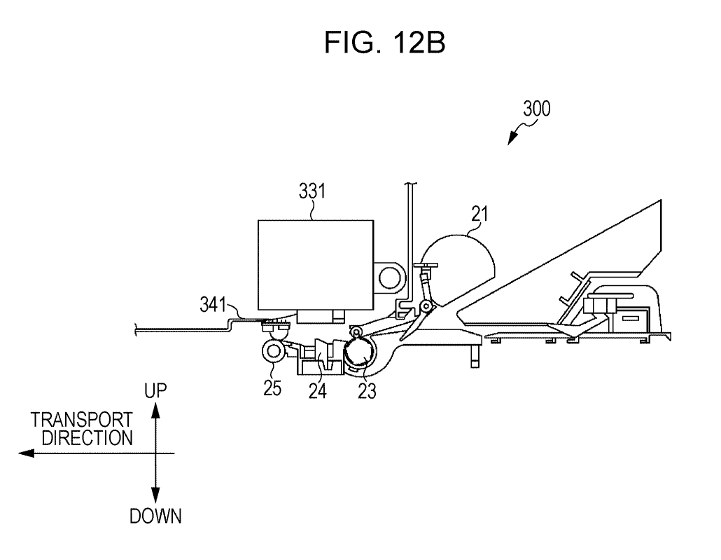

FIG. 12A is a block diagram schematically illustrating the general configuration of a serial printer 1. In addition, FIG. 12B is a cross sectional view illustrating the general configuration of a printer 300. Differences between the printers 1 and 300 are mainly described below.

The printer 300 includes a carriage unit 330. The carriage unit 300 is configured to move a head unit 340 in a direction of the width of paper. The carriage unit 330 includes a carriage 331 and a carriage motor 332. The carriage 331 can be reciprocated in the direction of the width of paper and is driven by the motor 332. In addition, the carriage 331 removably holds an ink cartridge containing ink as an example liquid.

The head unit 340 ejects the ink onto the paper 0. The head unit 340 includes a head 341 having a plurality of nozzles. Because the carriage 331 is provided with the head 341, the head 341 moves in the direction of the width of paper when the carriage 331 moves in the direction of the width of paper. And, the head 341 intermittently ejects the ink while moving the head 341 in the direction of the width of paper, so that a dot line (a raster line) along the direction of the width of paper is printed on the paper 0.

In the case of printing on the paper 0, the printer 300 alternately repeats a dot forming operation, in which the ink is ejected from the nozzles of the head 341 moving in the direction of the width of paper to form dots on the paper 0, and a transport operation, in which a transport unit 20 transports the paper 0 in a transport direction. In the case of the dot forming operation, the ink is intermittently ejected from the nozzles to form a dot line including a plurality of dots along the direction of the width of paper. This dot line is referred to as a raster line. A raster direction in the raster line (corresponding to “the direction of relative movement”) corresponds to the direction of the width of paper.

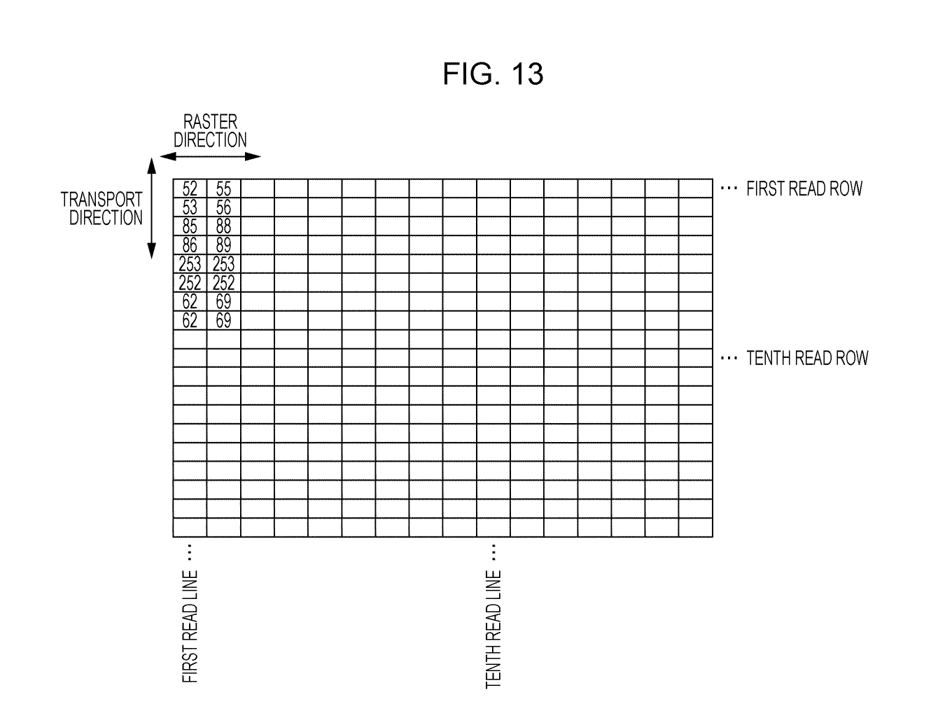

FIG. 13 is an explanatory diagram illustrating read data read with the scanner 210 in cases where the scanning rate is set at 7 ms. As shown in FIG. 13, with respect to cells formed by dividing a plane into a grid in the raster direction and in the transport direction, read data has positions of cells and pixel values read in the positions in association with each other. Accordingly, the plane is divided into a grid in the raster direction and in the transport direction in the second embodiment, whereas the plane is divided into a grid in the raster direction and in the direction of the width of paper in the first embodiment. Both embodiments differ with each other in that point, but there are no differences as for the rest.

A process flow of a detection process of defective liquid ejection in the second embodiment is the same as that shown in FIG. 9.

According to the second embodiment, because defective liquid ejection is detected for a maximum pixel value having a small change in the pixel value of an image, false detection can be prevented in the detection of defective liquid ejection. In addition, also in the second embodiment, the accuracy of the detection of defective liquid ejection is maintained, and a read resolution in the raster direction is lowered in the case of reading with the scanner 210, so that an amount of data to be processed is reduced in the detection of defective liquid ejection.

### Third Embodiment

In the first embodiment and second embodiment, image data is digitally processed to create the reference data (S₉₀₆ in FIG. 9). On the other hand, in a third embodiment, in cases where the same image is printed several times, printed material printed immediately after the cleaning or flushing of the head unit 40 is read with the scanner 210 to create the reference data. In other words, because there is not clogging of nozzles immediately after the cleaning or flushing, a high-quality printed material not having dot defects can be produced. This data created by reading the high-quality printed material can function as the reference data.

According to the third embodiment, defective liquid ejection is detected for a maximum pixel value having a small change in coloring of a image, so that false detection can be prevented in the detection of defective liquid ejection.

In addition, also in the third embodiment, the accuracy of the detection of defective liquid ejection is maintained, and read resolution in the raster direction is lowered in the case of reading with the scanner 210, so that an amount of processed data is reduced in the detection of defective liquid ejection.

### Other Embodiments

Furthermore, although the printers 1 and 300 for forming an image by liquid ejection have been described as examples of a liquid ejection device, the invention is not limited to these embodiments. It can be embodied in the detection of defective liquid ejection in liquid ejection devices for ejecting liquid other than ink (including liquid, liquid matter in which the particles of functional materials are dispersed, gel-like liquid matter, and a pulverulent matter which is an aggregate of fine powders)

For example, the invention may be applied to the detection of defective liquid ejection in a liquid ejection device used for ejecting a liquid including a material such as an electrode material or a color material used for a liquid crystal display, an electro luminescent (E1) display, or a surface emitting display in the form of a dispersion liquid and solution, a liquid ejection device used for producing a biochip for ejecting living organic materials, and a liquid ejection device used for a precision pipette for ejecting liquid as a sample. Furthermore, it may be applied to a detection of the defective liquid ejection in a liquid ejection device for ejecting lubricant oil to precision machinery such as a watch and a camera with pinpoint accuracy, a liquid ejection device for ejecting transparent resin such as ultraviolet curing resin onto a substrate to form a micro hemispherical lens (optical lens) used for an optical communication device, a liquid ejection device for ejecting acidic or alkaline etchant for etching a substrate, and a liquid ejection device for ejecting gel. In addition, the invention can be applied to the detection of defective liquid ejection in any one of the above liquid ejection devices.

The above embodiments are described to simplify understanding of the invention, and it should be understood that the above embodiments do not limit the scope of the invention. It should be understood that the invention can be changed and modified without departing from the scope of the invention and that the invention includes all equivalents thereof. In particular, the invention includes the embodiments described below.

### Head

The head 41 that ejects ink with a piezoelectric element is used in the above embodiments. However, a method for ejecting liquid is not limited to these embodiments. Other methods may be used, for example, a method for thermally generating bubbles in a nozzle.

### Process for Detecting Defective Liquid Ejection in Nozzles

In the first and second embodiments, image data is digitally processed into reference data (S₉₀₆ in FIG. 9). However, in cases where the resolution of image data is the same as that of read data, the image data can be directly used. In this case, it is not required to create the reference data.

The disclosure of Japanese Patent Application No. 2009-072465 filed Mar. 24, 2009 including specification, drawings and claims is incorporated herein by reference in its entirety.

What is claimed is:

1. A method for detecting defective liquid ejection comprising:
reading an image with a sensor, the image being formed on a medium on the basis of image data by ejecting liquid from a nozzle while relatively moving the nozzle in a direction of relative movement with respect to the medium;
specifying a maximum pixel among pixels of read data continuously arrayed in rows in a direction intersecting the direction of the relative movement in the data read with the sensor, the maximum pixel having the maximum pixel value among pixels of the read data;
selecting a selected pixel in the data read with the sensor, the selected pixel being included in a line constituted by a plurality of pixels including the maximum pixel arrayed in line in the direction of the relative movement; and
detecting defective liquid ejection in the nozzle by comparing the selected pixel with the pixel of the image data corresponding to the selected pixel in the image data.

2. The method for detecting defective liquid ejection according to claim 1, further comprising:
creating reference data on the basis of the image data, the reference data having the same resolution as the read data,
wherein the sensor performs reading in the direction of the relative movement so that the resolution of the read data is made to be lower than that of the image data in cases where an image formed on the medium is read with the sensor; and
wherein the selected pixel is compared with the pixel of the reference data corresponding to the selected pixel in the reference data in cases where defective liquid ejection of the nozzle is detected.

3. The method for detecting defective liquid ejection according to claim 1, wherein the sensor performs reading in the direction intersecting the direction of the relative movement so that the resolution of the read data becomes higher than that of the image data.

4. The method for detecting defective liquid ejection according to claim 1, wherein the reference data is created by processing the image data.

5. A defective liquid ejection detection device comprising:
a sensor for reading an image, the image being formed on a medium on the basis of image data by ejecting liquid from a nozzle while relatively moving the nozzle in a direction of relative movement with respect to the medium;
a specifying section for specifying a maximum pixel among pixels of read data continuously arrayed in rows in a direction intersecting the direction of the relative movement in the data read with the sensor, the maximum pixel having the maximum pixel value among pixels of the read data;
a selecting section for selecting a selected pixel in the data read with the sensor, the selected pixel being included in a line constituted by a plurality of pixels including the maximum pixel arrayed in line in the direction of the relative movement; and
a detector for detecting defective liquid ejection in the nozzle by comparing the selected pixel with the pixel of the image data corresponding to the selected pixel in the image data.
